(19) United States
(12) Patent Application Publication
(10) Pub. No.: US 2018/0196139 A1
(43) Pub. Date: Jul. 12, 2018

(54) SYSTEM FOR FREE-SPACE OPTICAL COMMUNICATION AND LIDAR

(71) Applicant: 8 RIVERS CAPITAL, LLC, Durham, NC (US)

(72) Inventors: William J. Brown, Durham, NC (US); Hannah Clark, Durham, NC (US); Michael W. Adams, Chapel Hill, NC (US); Glenn William Brown, JR., Durham, NC (US); Miles R. Palmer, Chapel Hill, NC (US)

(21) Appl. No.: 15/863,392

(22) Filed: Jan. 5, 2018

Related U.S. Application Data
(60) Provisional application No. 62/443,374, filed on Jan. 6, 2017.

(51) Int. Cl. G01S 17/87; H04B 10/112; G01S 17/10; H04B 10/43; H04B 10/50

(52) U.S. Cl. CPC G01S 17/87; H04B 10/1127; G01S 17/10; H01Q 5/22; H04B 10/503; H04B 10/1129; H04B 10/43

(57) ABSTRACT

A system and method are provided that sit at the intersection of high bandwidth mobile communications and light detection and ranging (LIDAR). The system and method expand on a diverged-beam free space optical system (DBFSO) and solves the LIDAR cost problem by describing a combined LIDAR/DBFSO system. One integrated hardware system provides the capability of both LIDAR and DBFSO, and in many configurations, both capabilities can operate at the same time, while reducing cost and complexity associated with two separate systems. The system can be stationary or mobile, and apply to both scanning and fixed configurations.

### CROSS-REFERENCE TO RELATED APPLICATION(S)

The present application claims priority to U.S. Provisional Patent Application No. 62/443,374, entitled: System for Free-Space Optical Communication and LIDAR, filed on Jan. 6, 2017, the content of which is incorporated herein by reference in its entirety.

### TECHNOLOGICAL FIELD

The present disclosure relates generally to optical communications and ranging and in particular, combined diverged beam free space optics and LIDAR.

### BACKGROUND

There has been a recent rise of autonomous vehicles and the need for both 3D spatial information around the vehicle and higher-bandwidth, lower-latency communications between vehicles and between vehicles and the network. Previously, light detection and ranging (LIDAR) systems used high power lasers with high speed detectors to build a 3D map of the surroundings. These systems were very high cost and typically deployable on aircraft to measure surface topology. Recent advancements have led to lower cost LIDAR systems that operate over tens of meters of range with costs of tens of thousands of dollars. Even so, LIDAR systems remain one of the most expensive parts of an autonomous vehicle system, inhibiting deployment.

LIDAR's primary focus is sensing and mapping the environment using light pulses, typically from lasers. The most common method of doing this is by sending a pulse from a laser and timing how long it takes to bounce off an object and return. Proximity to objects can be calculated by knowing the speed of light and hence the path length of the round trip. Very precise measurements utilize very high-speed detectors for the best timing resolution.

Communications, both mobile and fixed, have used radio frequency (RF) due to the wide angular range, extensive infrastructure built up as part of the cellular phone industry, and the high availability of short-range WLAN networks. However, there are two problems that remain unsolved for achieving high-bandwidth, low-latency communications: the availability (and in some regulatory regimes, the expense) of RF spectrum and the amount of bandwidth needed to support advanced operations, such as autonomy. As previously disclosed, the spectrum and high-bandwidth can be provided to mobile vehicles with diverged beam free space optics systems (DBFSO communication). Others are attempting to solve these problems through millimeter wave communications systems for increased bandwidth, but have issues regarding the size of the antenna and power consumption required to make them viable for mobile applications.

In fixed networks, the use of high-bandwidth (Gbps+), line-of-sight wireless networks is becoming more common, particularly evidenced by the use of such equipment in cellular backhaul, but also now in end-user connectivity. Many wired network providers have efforts focused on wireless provision of service, as they realize the high cost of fiber deployments to end-users. The networks need to be aware of the environment in the wireless channel to achieve the reliability end-users demand. However, in all cases, secondary systems are required to bring this awareness to the network.

There is a clear need for a unified, low-cost system which can perform both high bandwidth communications and LIDAR, whether for mobile or stationary applications.

### BRIEF SUMMARY

The present disclosure sits at the intersection of high bandwidth mobile communications and LIDAR. Example implementations of the present disclosure solve the problem of acquiring LIDAR information with a free space optical (FSO) communication system. That is, the same physical hardware can serve two purposes—transmitting and receiving data, and generating LIDAR information about the surrounding environment. The system sends pulses and measures time-of-flight to calculate distance to the scattering object. The system uses same hardware as a FSO communication system, and may have different optical and/or electronic processing. One example of a suitable FSO communication system is disclosed by U.S. Patent Application Publication No. 2016/0294472, which is incorporated by reference.

In addition, the LIDAR system can be passive (with no moving pieces) or active (with one or more moving pieces). LIDAR information can be obtain for the area within the field of view of the optical transceivers, or utilize pointing to map spaces outside the primary communications link field of view.

Some example implementations provide an FSO communication system that can also generate LIDAR-type information. That is, the system can measure distances as a function of direction to scattering objects as well as transmit and receive data from other FSO transceivers.

Previous work in this area has focused on airborne LIDAR systems that need to transmit large volumes of data back to a ground station. These systems use the traditional approach of very narrow divergence beams which is a requirement for both LIDAR and previous FSO systems.

The system described herein uses diverged beams and wide-acceptance-angle detectors to both transceive data and generate information about the environment. Expected distances are in the 1 to 1000 meter range, but could be farther. Previous systems have focused on transmitting the LIDAR data to a second location. The system described herein sends any data in both directions, not just LIDAR data on the downlink to a network.

Broad deployment of these systems on many locations, including vehicles and fixed infrastructure, will enable new features and functionality that are not available today. This includes real time updates of maps for transportation and other activities, monitoring of terrestrial traffic and airborne traffic including drone flights, real-time updates of infrastructure issues, and reconfiguration of mesh communications systems.

The present disclosure thus includes, without limitation, the following example implementations.

Some example implementations provide an optical receiver comprising a detector configured to receive light pulses emitted as light detection and ranging (LIDAR) pulses or communications pulses, and convert the light pulses to corresponding electrical signals; and electronic circuitry coupled to the detector, and configured to receive the corresponding electrical signals, and discriminate between LIDAR signals and communications signals corresponding to respectively the LIDAR pulses and the communications pulses based thereon.

In some example implementations of the optical receiver of any preceding example implementation, or any combination of any preceding example implementations, LIDAR pulses and communications pulses are assigned to different time windows, and wherein the electronic circuitry is configured to discriminate between the LIDAR signals and communications signals based on a window of the different time windows in which the light pulses are received by the detector.

In some example implementations of the optical receiver of any preceding example implementation, or any combination of any preceding example implementations, the electronic circuitry is configured to discriminate between the LIDAR signals and communications signals based on wavelength in which electrical signals of the corresponding electrical signals having one set of wavelengths are processed as LIDAR signals and electrical signals of the corresponding electrical signals having another set of wavelengths are processed as communications signals.

In some example implementations of the optical receiver of any preceding example implementation, or any combination of any preceding example implementations, LIDAR pulses and communications pulses are emitted with orthogonal polarizations, and the optical receiver further comprises polarization optics configured to pass light pulses of a polarization of one or the other of the LIDAR pulses and communications pulses, or selectively either of the LIDAR pulses and communications pulses, and wherein the electronic circuitry is configured to discriminate between the LIDAR signals and communications signals based on the polarization of the light pulses that the polarization optics are configured to pass.

In some example implementations of the optical receiver of any preceding example implementation, or any combination of any preceding example implementations, the electronic circuitry is configured to discriminate between the LIDAR signals and communications signals based on a signal threshold in which electrical signals of the corresponding electrical signals above the signal threshold are processed as LIDAR signals and electrical signals of the corresponding electrical signals below the signal threshold are processed as communications signals.

In some example implementations of the optical receiver of any preceding example implementation, or any combination of any preceding example implementations, the optical receiver is capable of being scanned over an angular range to generate an angular LIDAR map or to establish or maintain one or more communications links.

In some example implementations of the optical receiver of any preceding example implementation, or any combination of any preceding example implementations, the optical receiver is operable in a system including multiple optical receivers configured to cover a range of angles.

Some example implementations provide a system comprising an optical transmitter; an optical receiver; and electronic circuitry coupled to the optical transmitter and optical receiver, the electronic circuitry being configured to generate light detection and ranging (LIDAR) information and to transmit and receive data over one or more optical links via the optical transmitter and optical receiver.

In some example implementations of the system of any preceding example implementation, or any combination of any preceding example implementations, the optical transmitter, optical receiver and electronic circuitry reside in a vehicle and are configured to optically connect to a second system in another vehicle.

In some example implementations of the system of any preceding example implementation, or any combination of any preceding example implementations, the electronic circuitry is further configured to relay the LIDAR information to a fixed network over at least one of the one or more optical links.

In some example implementations of the system of any preceding example implementation, or any combination of any preceding example implementations, the electronic circuitry being configured to generate the LIDAR information includes being configured to measure distance to at least one other system using LIDAR pulses.

In some example implementations of the system of any preceding example implementation, or any combination of any preceding example implementations, the electronic circuitry being configured to measure distance to at least one other system includes being configured to measure distance to at least two other systems, and wherein the electronic circuitry is further configured to calculate a location of the system using the distance to the at least two other systems.

In some example implementations of the system of any preceding example implementation, or any combination of any preceding example implementations, the electronic circuitry being configured to generate the LIDAR information includes being configured to detect at least one airborne object using LIDAR pulses.

In some example implementations of the system of any preceding example implementation, or any combination of any preceding example implementations, the electronic circuitry being configured to transmit and receive data includes being configured to relay information about the at least one airborne object over at least one of the one or more optical links.

In some example implementations of the system of any preceding example implementation, or any combination of any preceding example implementations, the system comprises an imaging camera configured to generate image data coupled to the electronic circuitry, wherein the electronic circuitry is coupled to the imaging camera, and further configured to use the image data to identify a location of at least one other system, or integrate the image data with the LIDAR information.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described example implementations of the present disclosure in general terms, reference will now be made to the accompanying drawings, which are not necessarily drawn to scale, and wherein:

FIG. 1a illustrates an emitter, receiver, and electronics according to example implementations of the present disclosure and may include optics, camera, and example beams;

FIG. 1b illustrates a system according to example implementations of the present disclosure;

FIG. 2 illustrates time division between LIDAR and communications, according to example implementations;

FIG. 3 illustrates wavelength-division multiplexing with LIDAR and communications, according to example implementations;

FIG. 4 illustrates using polarization to distinguish LIDAR and communications, according to example implementations;

FIG. 5 illustrates using mixed powered pulses to distinguish between LIDAR and communications, according to example implementations;

FIG. 6 illustrates mapping roads with LIDAR and communications, according to example implementations;

FIG. 7a illustrates using a mechanical system to angularly change the direction where the comms/LIDAR system is transmitting and receiving;

FIG. 7b illustrates an omni-antenna with 360 degree horizontal coverage, according to example implementations;

FIG. 8 illustrates that both LIDAR and communications beams can be used to communicate information about the location of a drone or other flying object to vehicles and the network, according to example implementations; and

FIG. 9 illustrates vehicles using TOF information from one or more fixed nodes or each other to calculate absolute position and relay it to other vehicles or the network.

### DETAILED DESCRIPTION

The present disclosure will now be described more fully hereinafter with reference to example implementations thereof. These example implementations are described so that this disclosure will be thorough and complete, and will fully convey the scope of the disclosure to those skilled in the art. Indeed, the disclosure may be embodied in many different forms and should not be construed as limited to the implementations set forth herein; rather, these implementations are provided so that this disclosure will satisfy applicable legal requirements. As used in the specification and the appended claims, for example, the singular forms “a,” “an,” “the” and the like include plural referents unless the context clearly dictates otherwise. Also, for example, reference may be made herein to quantitative measures, values, relationships or the like. Unless otherwise stated, any one or more if not all of these may be absolute or approximate to account for acceptable variations that may occur, such as those due to engineering tolerances or the like.

A free space optical (FSO) communication system such as that disclosed by the previously cited and incorporated '472 patent application publication uses diverged optical beams and detectors with large acceptance angles to reduce or eliminate the pointing and tracking requirements of previous FSO systems. Multiple beams and detectors can be used to cover larger areas up to full 4 pi steradians, such as by using a modular, wireless optical omni-antenna. One example of a suitable omni-antenna is disclosed in U.S. patent application Ser. No. 15/451,092 to Adams et al., filed Mar. 6, 2017, which is incorporated by reference.

The aforementioned omni-antenna type systems can be modified to process LIDAR information in addition to communicating with other nodes.

A system according to example implementations of the present disclosure generally includes a plurality of nodes each of which includes one or more of either or both an optical transmitter or an optical receiver configured for fixed or mobile communication. In some examples, one or more optical transmitters and receivers may be co-located in the form of one or more optical transceivers. The system of example implementations may therefore include various combinations of one or more optical transmitters, receivers and/or transceivers.

The nodes may be implemented as or otherwise equipped by a number of different types of fixed or mobile communications devices and structures configured to transmit and/or receive data, or otherwise support the transmission and/or reception of data. Examples of suitable communications devices and structures include masts, telescopic masts, towers, poles, trees, buildings, balloons, kites, land vehicles, watercraft, spacecraft, celestial bodies, aircraft, computers, tablet computers, smartphones, and any of a number of other types of devices equipped for or otherwise capable of wireless communication.

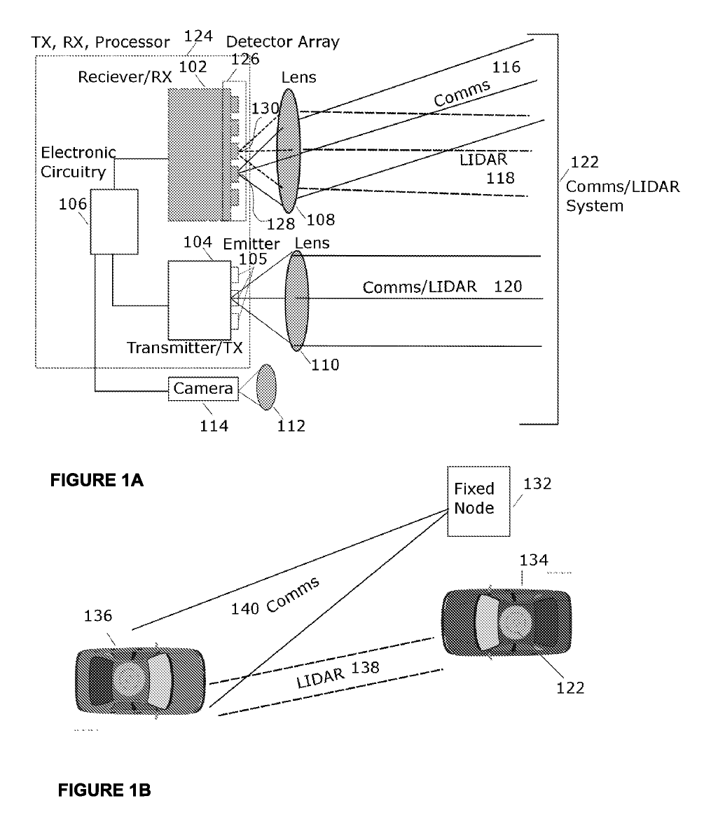

FIG. 1 illustrates a system 122 including an optical transceiver 124 with both an optical transmitter 104 and an optical receiver 102, according to some examples. As shown, for example, the optical transmitter may include one or more emitters 105 such as one or more laser diodes (an array of emitters—or emitter array—being shown for example), which may be coupled to respective supporting electronic circuitry 106, optics 110 or the like. Similarly, for example, the optical receiver may include with one or more detectors 126 such as one or more PIN photodiodes, avalanche photodiodes (APDs), photomultiplier tubes (PMTs) or the like (an array of detectors—or detector array—being shown for example), which may be coupled to respective supporting electronic circuitry 106, optics 108 or the like.

The supporting electronic circuitry 106 may include one or more of each of a number of components such as modulators, demodulators, processors and the like, and in some examples, at least the supporting electronic circuitry of both the optical transmitter and optical receiver may be co-located. In some examples, the supporting electronic circuitry may incorporate common electronics and processors to perform both signal processing and spatial data processing (described in greater detail below), such as custom FPGAs, ASICs and the like. In other implementations, it may be advantageous to have different processors and logic paths for the two functions.

In some examples, the optics 108, 110 may incorporate common lens and other optical components. In other examples, there may be distinct optical components, for instance to achieve more gain for either the communications or ranging functions, while maintaining common photonic (emitters/detectors) and electronic components for the functions. In some examples the optical components may be shared among various functions but be configurable to accommodate optimal performance of the different functions. The optical components may be configurable by mechanical movement of the lens and/or transmitter or detector. The lenses may be one or more liquid lenses with configurable focal length or direction via electric current.

For optical communication, the optical transmitter 104 with its emitter(s) 105, supporting electronic circuitry 106 and any optics 110 may be configured to emit an optical beam carrying data. The optical receiver 102 with its detector(s) 126, supporting electronic circuitry 106 and any optics 108 may be configured to detect the optical beam and recover the data from it. In accordance with example implementations of the present disclosure, the same emitter(s) that are used for optical communication can be configured to generate and emit pulses that can be used for LIDAR.

It is well-known that one of the biggest cost components of a LIDAR system are the high-precision optics and photonic components required. The costs are prohibitive to the point where some commercial LIDAR systems are built with narrow (10°) field of view, which is then rotated about an axis to provide 360° coverage. Example implementations of the present disclosure expand the use of those expensive components, opening up cost dollars which can be used to build higher functioning LIDAR system (more sensors, faster refresh rate).

One or more detectors 126 are located near the emitter(s) 105 and have a field-of-view that partially or fully overlaps with the optical emission area can be used to detect photons that are emitted by the emitter(s), then reflected or scattered off of elements in the surrounding area and finally returned to the detector(s). Simple distance measurements may be made by calculating time between the emission of a light pulse and the time it is detected by the detector(s) using the speed of light and any known information about the index of refraction of the transmission medium.

Time-of-flight may be calculated by using detector(s) 126 with multiple time bins and measuring the relative power in two or more time bins to determine the start of the light pulse relative to the edge of the time bin(s). This allows the use of longer light pulses and integration times provided that the rise and fall of integration bins are sufficiently sharp. As an example, consider a LIDAR system where the light pulse width is 100 ns and the integration time bin is also 100 ns. Using a first signal detection method, i.e., determining the first time bin where scattered light shows up, the system will have a resolution of ˜100 ns*speed of light/2 or about 15 meters in air.

However, if the signal level in the first and second time bins are used, the resolution can be vastly improved. One processing method is to subtract the signal magnitude in the second time bin from the signal magnitude in the first bin and divided by the sum of the magnitude of the two bins. If the result is 1, then the signal is fully in the first bin, if the result is 0 then the signal is equally split between the two bins and if the result is −1 then the signal is fully in the second bin. Resolution is now set by the signal-to-noise level in each bin, but could be 100 or more. If the SNR is ˜100 then the resolution for the 100 ns example becomes 100 ns*speed of light/(2*SNR) ˜0.15 meters, 15 cm. This works across a range of pulse times and integration times and can easily get to resolution of less than 1 cm. Using longer pulses and integration times potentially allows for more laser power and reduces the requirements on the detector(s) 126, particularly the digitization rate. Longer integration times also reduce any noise that is a function of the bandwidth of the detector(s).

There are several ways to separate the LIDAR information from communications information.

Typically in communication systems, the detector near a particular transmitter is detecting photons from another emitter which is part of a separate node. Thus light from the co-located emitter may interfere with light from the communications emitter. There are several ways to mitigate or eliminate this potential interference.

(1) Detector arrays can be used to spatially separate the types of optical pulses. Shown in FIG. 1a is an example of how a receiver 102 made from a detector array 126 could be implemented to detect both communications and LIDAR signals. Using a single lens optic 108, the optical pulses coming in from different directions 116 and 118, and are mapped to different elements 128, 130 of the multi-element detector array 126, and thus can overlap temporally since they are detected by different detectors elements. The system is comprised of a receiver (RX) 102 with a detector or detector array that may use a lens, transmitter (TX) 104 that sends both communications and LIDAR signals 120 and may use a lens 110 and electronic circuitry 106. Some systems may also include a camera 114 and camera optic 112. The TX, RX, and electronic circuitry make up a subsystem 124, while the inclusion of the any optics, cameras and other mechanicals form the Communications/LIDAR system 122. In one implementation (FIG. 1b) two vehicles 136, 134 (nodes 122) are aware of each other's presence and position using a LIDAR beam 138. Vehicle 136 is also communicating with the network or a fixed node 132 using a communications beam 140. Each vehicle has, for example, an optical receiver 102 with a detector array 126 depicted in FIG. 1a.

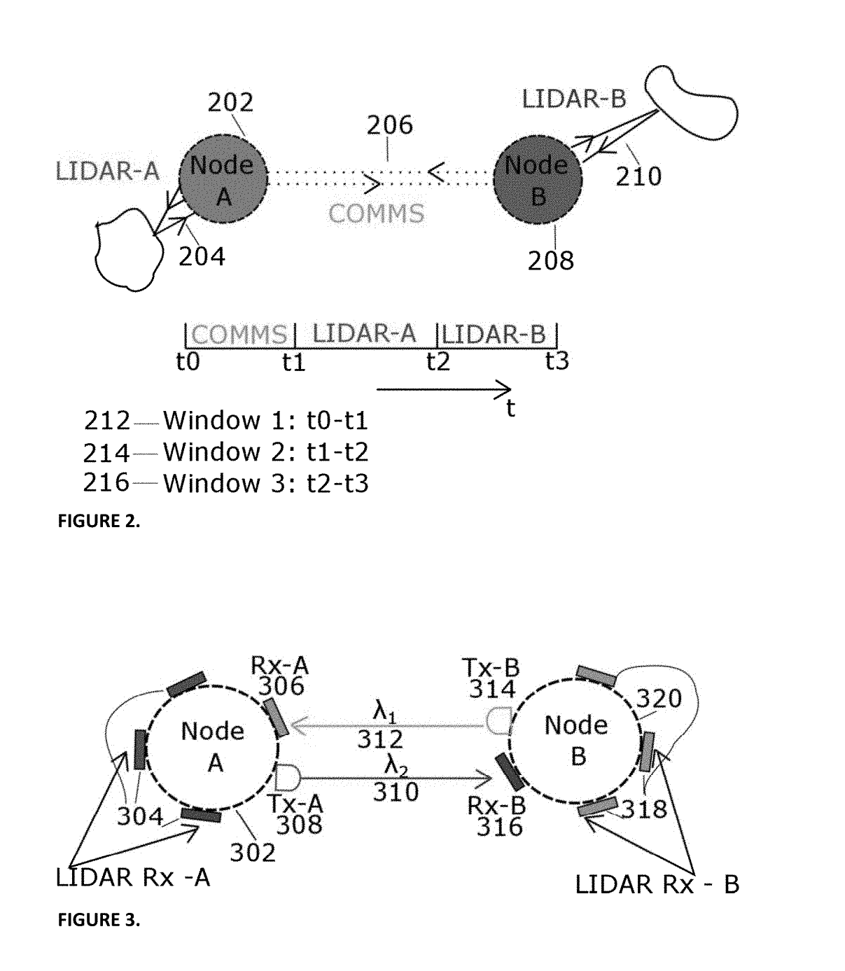

(2) In another approach, the system can use time division to keep communications pulses separate from LIDAR pulses. FIG. 2 depicts one such case where different time windows are assigned for communications and for LIDAR. Node A 202 and Node B 208 are communicating with each other via a communications link 206, but also using LIDAR beams 204 and 210 to detect objects near them. They use time division to keep the information separated and identifiable. For example, during Window 1 212 there will be a communications ling 206 between Node A 202 and Node B 208, during Window 2 214, Node A 202 will send out LIDAR pulse(s) 204 and receive them back and during Window 3 216 Node B 208 will send out LIDAR pulse(s) 210 and receive them back. The process may then repeat. Windows 2 214 and 3 216 will most often be long enough to allow pulses to propagate out to maximum distance to be measured and for scattered light to return. For example, to measure LIDAR up to 100 meters in air will most often take approximately 2*100 m/3e8 m/s=667 ns. The size of the windows, 212, 214, and 216 can be set as needed to trade off communications bandwidth versus repetition rate and distance of the LIDAR capability. In this and other implementation, the communications portion of the system would be equipped with enough information caching to provide for more seamless data transfer from the perspective of the network utilizing the communications link.

(3) Wavelength-division multiplexing (WDM) can also be used to keep communications separate from LIDAR as shown in FIG. 3. In this case, different wavelengths of light can be used to differentiate communications photons from LIDAR photons. For example, Node A transmitter 308 could use 850 nm 310 and Node B transmitter 314 could use 860 nm 312. LIDAR detectors on Node A 304 would have an 850 nm center wavelength (CWL) bandpass filter to detect the LIDAR pulses from Node A 302 and the communications detector on Node A 306 would have an 860 nm CWL filter so it could detect the communications light from Node B 320. Node B 320 would be configured in the opposite manner where its LIDAR detectors 318 would have filters with a CWL of 860 nm and its communications detector 316 would have a bandpass filter with CWL of 850 nm. Filters could be tunable, particularly tunable in time to allow one detector to be used for both wavelengths. In general, one set of one or more wavelengths would be used for LIDAR and a second set of one or more wavelengths would be used for communications.

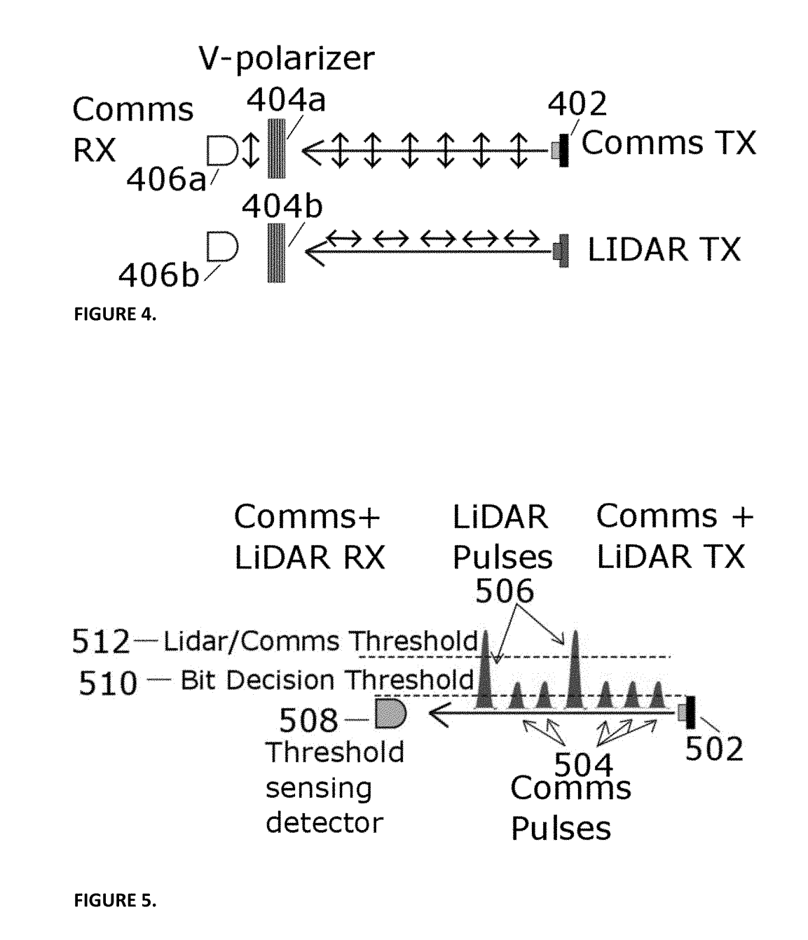

Another approach uses crossed polarization depicted in FIG. 4. In this case the emitter should be as linearly polarized as possible and the LIDAR detector should look for the orthogonal polarization. For example, the communications emitter 402 is emitting vertically polarized light and the communications detector 406a has a vertical polarizer 404a in front of it. The LIDAR transmitter 408 emits horizontally polarized light which does not pass through the vertical polarizer 404b and thus is not seen by the communications receiver 406b. The LIDAR detector (not shown) has a horizontal polarizer in front of it and the same concept applies here as the communications detector. This will work for any combination of orthogonal polarizations (linear or circular or other).

In another implementation, a single polarizer whose polarization axis changed with time could be used so that the same detector is used for both communications and LIDAR.

In another implementation, a polarizing beamsplitter or other polarization optics could be used with two detectors to simultaneously receive communications and LIDAR photons from the same field of view.

(4) Another implementation uses forward error correction (FEC) to overcome bit losses due to LIDAR pulse. The same detector for communications and LIDAR at the same time as shown in FIG. 5. As one example the emitter 502 would send out a high power LIDAR pulse 506 interspersed amongst the communications pulses 504. The pulse power should most often be high enough to differentiate from the communications bit levels.

The detector would detect the communications bits as is typically done and would have a threshold detector 508 for the sensing the LIDAR power where the bit decision threshold 510 is used to decide if the bit is valid data or noise and the LIDAR/Comms decision threshold 512 is used to decide if the bit is a high powered LIDAR pulse 506 or a standard communication pulse 504. The LIDAR pulses may disrupt the communications pulses, since they can arrive at any point in time after they are launched, and the system may use FEC to correct the interfered bits. It may be advantageous for the LIDAR pulse width to be less than the number of running bits that the FEC can correct.

Alternately, the LIDAR pulse threshold 512 may be lower than the communications threshold 510. The communications bit threshold is typically set midway between the zero level and 1 level for on/off keying (OOK), thereby generating a similar number of errored zeros and errored ones. For the LIDAR pulses, a lower threshold level may suffice as the system may only need to a sufficient probability that the signal level is above the noise floor.

LIDAR pulses can be many times power level of communications pulse (2 times to 1000s of times).

Since LIDAR uses backscattered light, higher pulse powers are advantageous. LIDAR pulses travel from the emitter to an object, scatter off the object over some angular range and return to the detector. Thus compared to a communications signal over a given distance, the LIDAR pulse may experience 4 times the loss (twice the distance) plus the scattering loss which may be a factor of 2 to 100 or more.

Lasers used as emitters in communications setups are typically operated in a 50% duty cycle configuration, meaning that, over any time period that is long compared to a bit cycle, the laser will be on for roughly half of the time. Most lasers can achieve much higher peak powers if they are operated at lower duty cycles. For some lasers, the peak power roughly follows a square root law—the peak power is approximately squareroot(1/duty cycle) so for a 10% duty cycle the peak power is 3.3 times the continuous wave (CW) power and for a 1% duty cycle the peak power is 10× the CW power.

Considering the case of a 100 meter LIDAR using time division, there should most often be a deadtime of 670 nanoseconds (due to speed of light) after LIDAR pulse is emitted before the communications pulses resume. If the LIDAR pulse is 1 ns (from a gigabit communications system) then the duty cycle is ˜1/670 and the peak power can be ˜25 times the CW power.

For the mixed signal case it may be necessary to have some deadtime after a LIDAR pulse before a communications pulse or the communications pulse heights may be reduced to allow higher peak pulse for the LIDAR pulse. For example if the communications pulses are run at 90% of maximum possible then 10% of CW capacity is available for the LIDAR pulses and a 1 nanosecond pulse every 10 milliseconds (0.01% duty cycle) could still be squareroot(1/0.0001)*10%=10 times the CW power.

Use Omni-Antenna to Get Info from Multiple Directions.

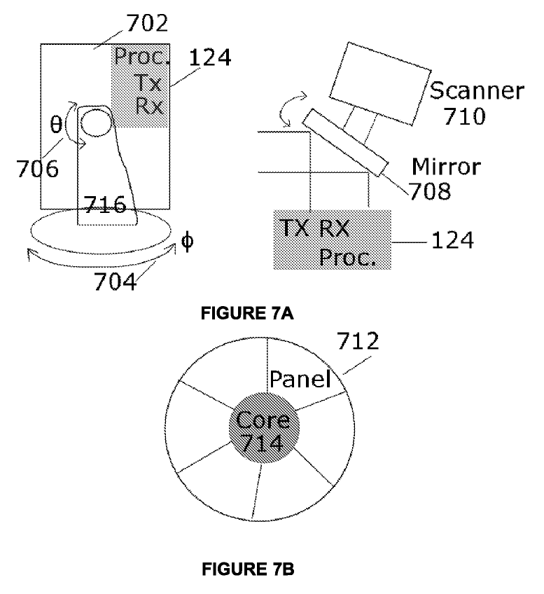

The description thus far has focused on various techniques for generating and processing LIDAR information and communications from a single field-of-view. The concept covers as many emitters (and/or arrays) and detectors (and/or arrays) as an omni-antenna may have. As previously described, an omni-antenna FIG. 7b may be made up of numerous panels 712 with their own fields-of-view where all panels are connected to a core 714. Within a panel, there may be one to many emitters and detectors with, particularly the detectors, each having their own fields-of-view.

As in any LIDAR system, each detector can generate a time series of data from a pulse or pulses of light. Any known LIDAR processing techniques can be used in this case to analyze and process the data including, but not limited to, first returning signal, strongest returning signal, signals passing through vegetation, etc.

The lateral resolution of this system is set by the field-of-view of each addressable detector element. This can range from 10's of degrees (10's of radians) down to milli-degrees (10's of milliradians) resolution. As larger detector arrays are used to increase speed and decrease impact of ambient light, the spatial resolution of the LIDAR capability will increase.

One example of an omni-antenna system has 18 panels and each panel covers +/−10 degrees vertically and horizontally. If a 10×10 detector array is used in each panel, then each detector covers ˜2 degrees by 2 degrees. At a range of 100 meters the resolution for LIDAR information is ˜3.5 meters square. Likewise, at 10 meters the resolution is 0.35 meters square. The number of detectors can easily be increased in each direction. For example, a 1 megapixel camera is now readily available and low cost so using 18 panels with a 1,000×1,000 array (1 megapixel) the resolution at 100 meters is 35 cm and at 10 meters is 3.5 cm.

The time resolution is generally set by a combination of the rise time of the emitter, the rise time of the detector, and the delays in associated electronics. In some examples, lasers with a 500 picosecond rise time have been used even faster, with sub-100 picosecond rise times available on other devices. At 3.0e8 m/s for the speed of light, 1 nanosecond corresponds to ˜33 cm or a round trip resolution of ˜16 cm. A 100 picosecond rise time gives ˜1.6 cm resolution.

In this configuration the system may have few or no moving parts. That is, the field of view of the system may be sufficient to cover the areas that need LIDAR and/or communications. In addition, the panels may be co-located or in separate locations. For example, on a car, all the panels could be mounted in a bubble on top of the roof, or there may be a few panels located at each corner of the car in the bumper or some other location. This implementation may have much faster refresh rates for the LIDAR as compared to the 10 Hz refresh rate that is typical on current commercial LIDAR systems. As discussed, these systems can easily do megahertz refresh rates and could ultimately go as fast as the emitter can be modulated, gigahertz or more.

Generating Angular LIDAR Maps Through Angular Pointing

Angular LIDAR maps are useful for terrain mapping and more accurate object identification. A Communications/LIDAR system can be rotated in both polar and azimuthal directions to obtain data from different angles. In FIG. 7a, the subsystem 124 is installed in a mountable case 702 that is mounted to a mechanically rotating mount 716 and allows for motion in the polar 706 direction or the azimuthal direction 704. These mechanical pointing systems may include rotation stages, motors, actuators, and bearings that allow for the angular rotation of the Communications/LIDAR system. They may or may not include feedback loops that use incoming Communications/LIDAR information to control the angular position.

Scanning Systems

Other implementations of the system may use scanning of the beam or beams to generate LIDAR over some angular range, similar to today's commercially available LIDAR systems. One example shown in FIG. 7a uses a mirror 708 on a mechanical mount or scanner 710 to steer either transmit beam, receive beam or both in a chosen direction. In these systems, the angular range for scanning is then mechanically moved in a circle around the horizon. In such configuration, the scanning range can also be used to point the transceiver to other transceivers, thus making a communications link. These include mechanically steering or pointing the emitter (or transmitter) and/or the detector (or receiver), or both. Phased array implementations, which require no mechanically movements, may also be used for pointing or steering. The LIDAR and communications transmit beams may be the same beam and point together, or may be different beams with the same pointing or may be different beams with different pointing. Likewise the receiver may use the same detector for LIDAR and communications and be scanned or pointed or may be different detectors (or arrays) that are pointed at the same location at the same time or may be different detectors (or arrays) that point at different locations at any given time.

In these scanning systems it may be the case that the communications only works for some portion of the time; for example the part of the scan where the beam is pointed at another receiver (fixed or mobile). This may reduce the overall data throughput, but still be fast enough to be useful. As an example, if the beam does a 360 degree rotation at 10 Hz with a beam divergence and acceptance angle of 2 degrees, then communications will happen for 1/180 of each rotation. For a 1 Gbps transmission link, the data throughput is now 5.5 Mbps with a latency as high as 100 milliseconds. In another implementation the beam may only scan over 20 degrees; now the communications duty cycle is 10%, so the throughput is 100 Mbps with the latency set by the sweep rate.

Systems with Camera

Systems have been described with several different detector implementations including detector arrays. These detectors may be used as cameras, i.e., may be used to generate 2D image information or video sequences over time, but it may also be advantageous to have one or more additional cameras in the system. These cameras may operate at the LIDAR or communications wavelengths and other wavelengths as well. For example, there are many CMOS (complementary metal-oxide semiconductor) sensors now available that are sensitive out to 900 nm or higher wavelengths. They can be used to see the LIDAR or communications wavelengths as well as visible or other wavelengths. Other materials and camera architectures may be used as will, including CCD's, InGaAs, and others.

These cameras may be configured to generate image data used to identify locations of other LIDAR/communications systems. This information may be used to point the communications beam to one or more other systems. The camera may also be used to generate additional image data that may be integrated with the LIDAR generated data. This integration and/or processing may happen locally or at another location.

Full Electromagnetic Spectrum

The system has been described primarily in terms of near infrared light, but the innovation works across the full electromagnetic spectrum. Different wavelengths may be more advantageous for different use cases and embodiments. As an example, using light further into the IR part of the spectrum may be advantageous due to reduced background light from the sun.

The system of example implementations of the present disclosure may be applied in a number of different manners, a number of examples of which are provided below. In some examples, the communications link may be used to transmit information generated by LIDAR system. The LIDAR system may generate information that will be useful to other entities besides the one where the LIDAR/DBFSO system is located. The communications link may be used to transmit some or all of the LIDAR information to other entities or networks. Some examples are given:

### Example #1: In Vehicle Hybrid System

Object Detection—

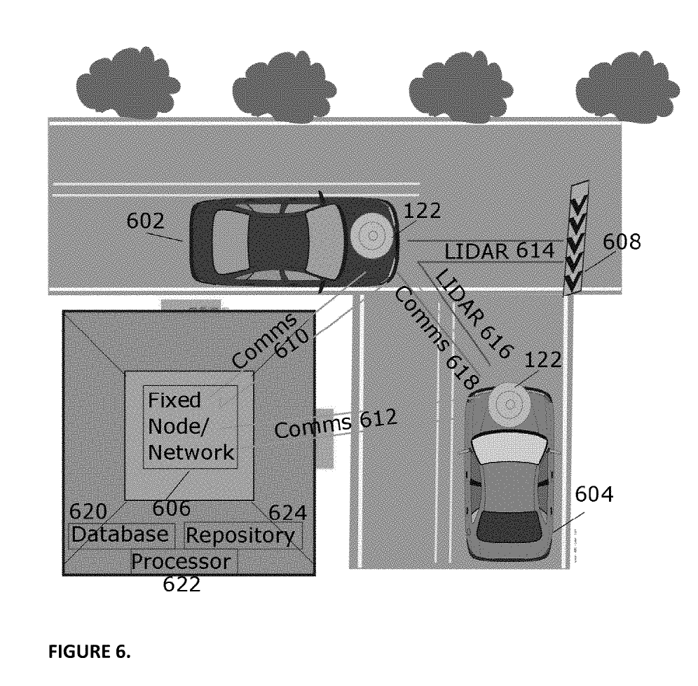

In this case, the system may map the environment around each vehicle (an example is depicted in FIG. 6). Here, a vehicle 602 maps the objects around it including the other vehicle 604 using 616, and the road sign 608 using 614 generated by the LIDAR/communications system 122. Communications beams 610 and 612 are used to send this information along with other various needed information from the fixed node or network 606. One vehicle 602 may use a LIDAR beam 616 to map out the position of another vehicle 604 while simultaneously communicating with it using a communications beam 616.

LIDAR information most often includes other vehicles but also anything else in the environment including roads, road conditions (rain, snow, etc.), infrastructure, road work, vehicles on the side or median of the road, etc. Roads are fairly well mapped, but dynamic aspects may be missing from current systems. The LIDAR information, combined with the vehicle location and orientation (from GPS or other systems) can be combined to provide a multi-dimensional map around the vehicle. This includes three dimensions of spatial location data and the time dimension as vehicles and other objects move. This data will need to be transmitted to other vehicles or networks to be useful. The communications portion of the system may be used for this data transmission.

Collision Detection—

LIDAR and RADAR are currently used in collision avoidance and automatic braking in vehicles. The integrated communications/LIDAR system can easily be used for this application. As an example, the braking distance from 60 mph (˜100 km/hour) is 143 ft for a typical minivan. In this regard, 143 ft=43.5 meters, from 100 km/hr to 0 assuming constant deceleration takes 3.3 seconds. LIDAR operating at anything above 10 frames/second will most often add negligible time to the stopping time. Lasers as emitters can easily operate up to 1 megacycle per second. Detectors may operate at nanosecond time scale for communications, and while peak detection over many detectors may operate at a slower rate, 1 megasample per second per detector is certainly possible. This allows a larger field of view for the collision avoidance system while maintaining the high speed communications capability.

Information can be Relayed to Other Vehicles—

Information can be sent back to central database 620 to update terrain, road conditions etc. Combination of LIDAR and communications allows rapid acquisition and transmission of data from one vehicle to other vehicles and/or to one or more databases. Transmission to other vehicles may include direct transmission using our diverged beam FSO, or RF or millimeter wave, to increase coverage area and either may include other transmission mediums.

A repository 624 may collect data from one or more vehicles and update the information in the repository. This information may be consolidated, filtered and otherwise processed to extract the most useful information and reduce the quantity of information that needs to be shared with vehicles. This may be an on-going process with new data coming in from vehicles that are operating, and updated repository information being shared with vehicles. Data may be transmitted back to the vehicles via the optical links or other communications links. This system may operate in a real-time, or nearly real-time, configuration.

In another configuration the LIDAR and communications may be short range enough that they are only used to detect and/or communicate to other vehicles. For example, there could be a LIDAR/FSO system in the front and back bumper of each vehicle and these systems would detect other vehicles around this vehicle using the LIDAR and then communicate with those vehicles nearby that also have LIDAR/FSO systems. These vehicles may have other LIDAR or communications systems for longer range or greater angular coverage.

Vehicles—

Vehicles may include cars, trucks, trains, boats, airborne vehicles, submarines, balloons, space vehicles and an others.

### Example #2: Mapping Physical World Between Nodes of a Mesh Network

FIG. 7 illustrates an omni-antenna with 360° horizontal coverage, according to example implementations of the present disclosure. The omni-antenna consists of panels 712 and a core 714. In an omni-antenna enabled mesh network, there are advantages to having the nodes be aware of the physical environment that exists between them and other nodes for network maintenance and resiliency. This 3D spatial information can be used to predict potential link failures and readily know how to change the network topology to address such a failure. The 3D spatial data can also be used to interpret changing weather and atmospheric conditions, and thus used to modify panel settings to increase signal strength by increasing power or focusing beam divergence.

In such a mesh-network, the information obtained can be utilized for multiple applications outside of network maintenance, such as activity monitoring and security. In a mesh configuration, the combined 3D spatial data will most often have advantages over data acquired by a single LIDAR system, as it will have a field-of-view to the front and back of areas between nodes.

### Example #3: Monitoring Physical Activities Between Nodes of a Mesh Network

In public safety, there is a growing need for information gathering that is both more detailed and less intrusive. Point cloud information from a connected mesh of wireless optical communications nodes can provide evidence of motion and activity in the entire coverage area of the mesh. This information would have positive impacts on public safety, while maintain privacy of citizens.

In some examples, this would include information about particulates and compounds floating and blowing in the air in the field of view of the LIDAR, such as dust particles, water particles, pollution particles, chemical agents, and biological agents such as anthrax. This information would be highly valuable for improving knowledge, timing, and safety regarding meteorological conditions, pollutions, and terrorist attacks.

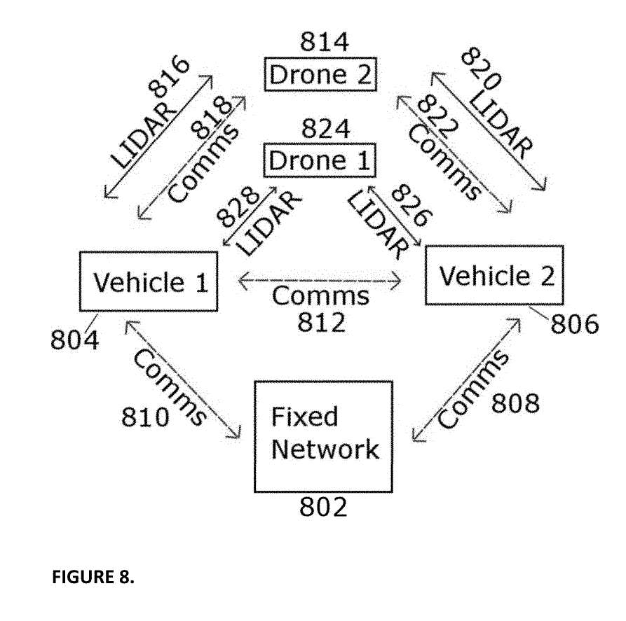

In some examples, this would include information about flying objects in the field of view of the LIDAR, such as drones depicted in FIG. 8. This information could include physical location relative to the system, velocity information based on either multiple data sets collected over time or Doppler information obtained from the LIDAR pulses, and/or acceleration information based on multiple velocity data points collected over time. Other information could include physical aspects of the flying object such as size, number for rotors, and/or rotor speed.

FIG. 8 depicts Vehicle 1 804 and Vehicle 2 806 that communicate with each other and with a fixed network 802 or node. Drone 2 814 is a friendly drone and LIDAR pulses 816, 820 between Drone 2 814 and either Vehicle 1 804 or Vehicle 2 806 alert its presence, and can potentially trigger an optical communications channel 818, 822 to open with either Vehicle 1 804, Vehicle 2 806, or both. The information transferred over the communication channel could include drone identification information, flight path, operator, etc. Information could come from sensors on the drone including cameras or other FSO/LIDAR systems. Vehicle 1(2) 804(806) may then transmit this information with Vehicle 2(1) 806(804) or the fixed network 802.

In some examples, the drone would not communicate with the system. This is shown by Drone 1 824 where LIDAR pulses have detected its presence 826,828, but does not have a communication channel to identify itself. In this case, the drone might be involved in illegal activity such as terrorism, and this example could raise an alarm to the proper authorities with detailed real time information about the drone and its highly resolved position versus time. This information may be passed via the fixed network 802 or other means.

In some examples, the drone's preplanned and preapproved flight plan data at high resolution would be available within the LIDAR control system. The system would then compare the actual drone track versus the preapproved track and raise alarms as appropriate based on deviations beyond certain limits that could be established by proper authorities. Other deviations would not raise alarms but would be used to establish detailed maps of meteorological conditions that could be used for improved weather forecasting and communicated to other drones flying in the area. This system may operate in real-time or nearly real-time.

### Example #4: Providing Beacon Information for Autonomous Vehicles

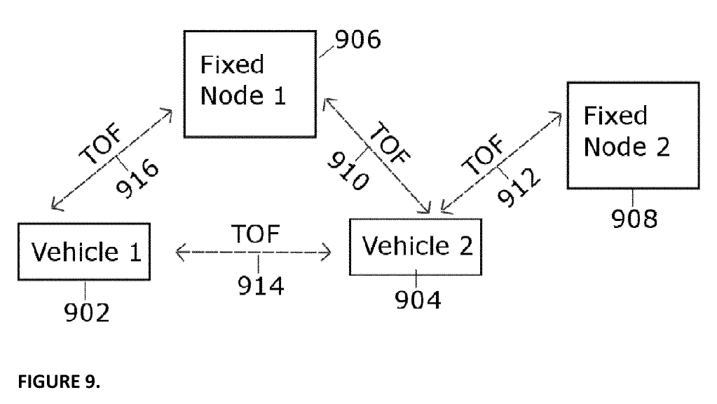

In addition to providing data communication, a fixed node may provide beacon information to a mobile node, as shown in FIG. 9. Both distance and directional information can be provided. Fixed Node 1 906 may communicate with both Vehicle 1 902 and Vehicle 2 904 and shares time-of-flight (TOF) information with them, 916 and 910 respectively. Fixed Node 2 908 may shares TOF information with Vehicle 2 912. Using both pieces of TOF information from the fixed nodes, Vehicle 2 904 can calculate its position and share that with Vehicle 1 902, along with TOF information to Vehicle 1 914. Vehicle 1 902 may then calculate its position. This may be faster and more accurate than GPS location data or may work in locations where GPS is unavailable or compromised. Mobile nodes may use information from one or more fixed nodes. Information from one or more other mobile nodes may also be used. In some instances, the mobile node may use Doppler information from its LIDAR beam to determine velocity as well as location.

The mobile node may determine the direction to a fixed node by use of a camera or by one or more photodiodes set up to receive light preferentially from a direction. The camera may be part of a tracking system for the mobile node. The mobile node may use its LIDAR capability or use round trip time of flight to determine the distance to a fixed node. Combined with location information from the fixed node, the distance and direction information may allow the mobile node to determine where it is.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosures are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An optical receiver comprising:
a detector configured to receive light pulses emitted as light detection and ranging (LIDAR) pulses or communications pulses, and convert the light pulses to corresponding electrical signals; and
electronic circuitry coupled to the detector, and configured to receive the corresponding electrical signals, and discriminate between LIDAR signals and communications signals corresponding to respectively the LIDAR pulses and the communications pulses based thereon.

2. The optical receiver of claim 1, wherein LIDAR pulses and communications pulses are assigned to different time windows, and
wherein the electronic circuitry is configured to discriminate between the LIDAR signals and communications signals based on a window of the different time windows in which the light pulses are received by the detector.

3. The optical receiver of claim 1, wherein the electronic circuitry is configured to discriminate between the LIDAR signals and communications signals based on wavelength in which electrical signals of the corresponding electrical signals having one set of wavelengths are processed as LIDAR signals and electrical signals of the corresponding electrical signals having another set of wavelengths are processed as communications signals.

4. The optical receiver of claim 1, wherein LIDAR pulses and communications pulses are emitted with orthogonal polarizations, and the optical receiver further comprises polarization optics configured to pass light pulses of a polarization of one or the other of the LIDAR pulses and communications pulses, or selectively either of the LIDAR pulses and communications pulses, and wherein the electronic circuitry is configured to discriminate between the LIDAR signals and communications signals based on the polarization of the light pulses that the polarization optics are configured to pass.

5. The optical receiver of claim 1, wherein the electronic circuitry is configured to discriminate between the LIDAR signals and communications signals based on a signal threshold in which electrical signals of the corresponding electrical signals above the signal threshold are processed as LIDAR signals and electrical signals of the corresponding electrical signals below the signal threshold are processed as communications signals.

6. The optical receiver of claim 1, wherein the optical receiver is capable of being scanned over an angular range to generate an angular LIDAR map or to establish or maintain one or more communications links.

7. The optical receiver of claim 1, wherein the optical receiver is operable in a system including multiple optical receivers configured to cover a range of angles.

8. A system comprising:
an optical transmitter; an optical receiver; and
electronic circuitry coupled to the optical transmitter and optical receiver, the electronic circuitry being configured to generate light detection and ranging (LIDAR) information and to transmit and receive data over one or more optical links via the optical transmitter and optical receiver.

9. The system of claim 8, wherein the optical transmitter, optical receiver and electronic circuitry reside in a vehicle and are configured to optically connect to a second system in another vehicle.

10. The system of claim 8, wherein the electronic circuitry is further configured to relay the LIDAR information to a fixed network over at least one of the one or more optical links.

11. The system of claim 8, wherein the electronic circuitry being configured to generate the LIDAR information includes being configured to measure distance to at least one other system using LIDAR pulses.

12. The system of claim 11, wherein the electronic circuitry being configured to measure distance to at least one other system includes being configured to measure distance to at least two other systems, and wherein the electronic circuitry is further configured to calculate a location of the system using the distance to the at least two other systems.

13. The system of claim 8, wherein the electronic circuitry being configured to generate the LIDAR information includes being configured to detect at least one airborne object using LIDAR pulses.

14. The system of claim 13, wherein the electronic circuitry being configured to transmit and receive data includes being configured to relay information about the at least one airborne object over at least one of the one or more optical links.

15. The system of claim 8 further comprising an imaging camera configured to generate image data coupled to the electronic circuitry,
wherein the electronic circuitry is coupled to the imaging camera, and further configured to use the image data to identify a location of at least one other system, or integrate the image data with the LIDAR information.
